(19) United States
(12) Patent Application Publication
(10) Pub. No.: US 2004/0007795 A1
(43) Pub. Date: Jan. 15, 2004

(54) Bowling ball thumb-hole duplication jig and methods of use

(76) Inventors: David R. John, Pocatello, ID (US); Steven M. John, Boise, ID (US)

Correspondence Address: Charles R. Clark, P.O. Box 842, Boise, ID, 83701-0842, US

(21) Appl. No.: 10/196,468

(22) Filed: Jul. 15, 2002

(51) Int. Cl. B26D 5/08

(52) U.S. Cl. 264/219; 425/295

(57) ABSTRACT

An apparatus and methods for duplicating a thumb-hole of an original bowling ball into another bowling ball are disclosed. The preferred apparatus includes a bowling ball thum-bhole duplication jig for holding an original bowling ball during the casting of a flexible mold of a thumb-hole of the ball. A preferred method employs components of the jig and the flexible mold in the making of a slug for insertion into a radial slug receiving bore of another bowling ball.

### BACKGROUND OF THE INVENTION

The present invention relates to a novel apparatus and methods for the duplication of a bowling ball thumb-hole from an original bowling ball into another bowling ball that simplifies the procedure from other known processes.

In U.S. Pat. No. 5,813,918 issued to Conigliaro is addressed an invention entitled “Method of exactly duplicating in a new bowling ball, the thumb-hole of a reference bowling ball.” In U.S. Pat. No. 4,191,357 issued to Nesbitt, a duplicator for bowling ball finger and thumb holes is addressed. These prior devices use different apparatus and steps for the duplication of a thumb-hole from an original bowling ball into another bowling ball.

### BRIEF SUMMARY OF THE INVENTION

A principal objective of this invention is to provide a novel and improved bowling ball thumb-hole duplication jig and methods of use that have utility and allow the interior thumbcontacting topography and orientation of a thumb-hole from an original bowling ball to be duplicated into another bowling ball.

A further objective is to provide an apparatus and methods that ensure compliance with the regulations governing bowling balls prescribed by the American Bowling Congress. One of the regulations establishes that the maximum diameter of a hole drilled into a bowling ball is 1 and ⅜ inches. Another American Bowling Congress regulation establishes the balance parameters that a ball with thumb-hole and finger holes must meet.

The apparatus of the invention provides a novel clamping jig that securely holds an original bowling ball with an existing thumb-hole and effectively seals the end of a tube that encircles the thumb-hole to the ball without the need for sealing clay or other sealing materials before the pouring and casting of a flexible mold of the existing thumb-hole.

The apparatus provides a stable tool for holding the mold during the pouring and casting of a thumb-hole slug that thereafter can be inserted into and secured in a radial slug receiving bore of a second bowling ball. A slug is a molded sleeve insert that possesses nearly the same interior thumb-contacting topography as the original thumb-hole of the original bowling ball.

A further object of the invention is to provide a timesaving and useful method and apparatus for the duplication of a thumb-hole from an original bowling ball into another bowling ball.

Additional and various other objects and advantages attained by the invention will become more apparent as the specification is read and the accompanying figures are reviewed.

### BRIEF DESCRIPTION OF THE SEVERAL VIEWS OF THE DRAWING

FIG. 1 is a schematic perspective view of a bowling ball thumb-hole duplication jig in the preferred embodiment showing an original bowling ball in place;

FIG. 2 is a schematic exploded perspective view of the bowling ball thumb-hole duplication jig in the preferred embodiment showing all of its component parts without a bowling ball in place;

FIG. 3 is a schematic enlarged, partial, and partially cutaway view of the jig and an original bowling ball;

FIG. 4 is a sectional view of the jig and the ball along the line 4-4 in FIG. 3;

FIG. 5 is a sectional view of the jig and the ball along the line 4-4 in FIG. 3 with a mold shown;

FIG. 6 is a partial sectional view of the jig, the ball, and the mold along the line 6-6 in FIG. 3;

FIG. 7 is a partial side elevational view of the mold and the ball showing a mold registration marking aligned with a y-axis of the grip of the ball;

FIG. 8 is a perspective view of the mold;

FIG. 9 is a sectional view of a bridge, a tube, a mold, and a slug;

FIG. 10 is a perspective view of the mold and the slug;

FIG. 11 is a schematic exploded perspective view of the slug aligned for insertion into a slug receiving bore of a second bowling ball; and

FIG. 12 is a schematic perspective view of the slug mounted in a second bowling ball; and

FIG. 13 is a partial top view of the slug mounted in the second bowling ball.

### DETAILED DESCRIPTION OF THE INVENTION

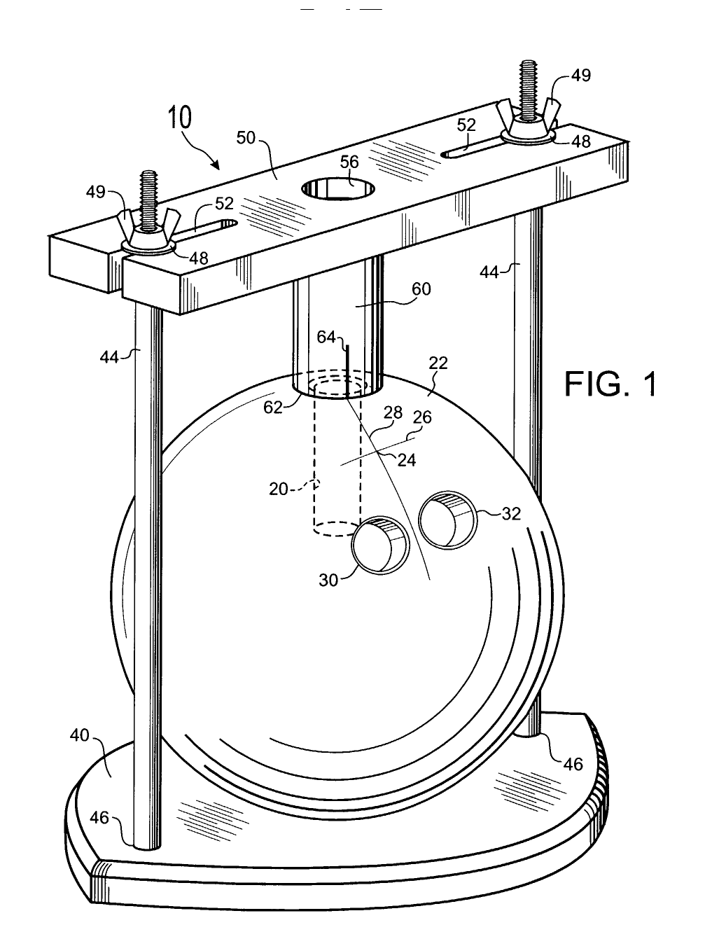

Referring to FIG. 1, the invention is novel and provides a bowling ball thumb-hole duplication jig 10 that beneficially assists in novel methods of duplicating a thumb-hole 20 of an original bowling ball 22 into another bowling ball. Preferably the ball 22 has markings on its surface that show a center of the grip 24, an x-axis of the grip 26, and a y-axis of the grip 28. Generally, the markings are scribed lines. It is generally well known in the art that the thumbhole 20 is centered on the y-axis of the grip 28. Preferably the scribed line showing the y-axis of the grip 28 extends along the surface of the ball 22 and intersects the original thumb-hole 20 and bisects two finger holes 30 and 32.

In the event the ball 22 does not have a marking along the y-axis of the grip 28, then the ball may be scribed or temporarily marked with a crayon or other suitable marking device to show the y-axis of the grip 28.

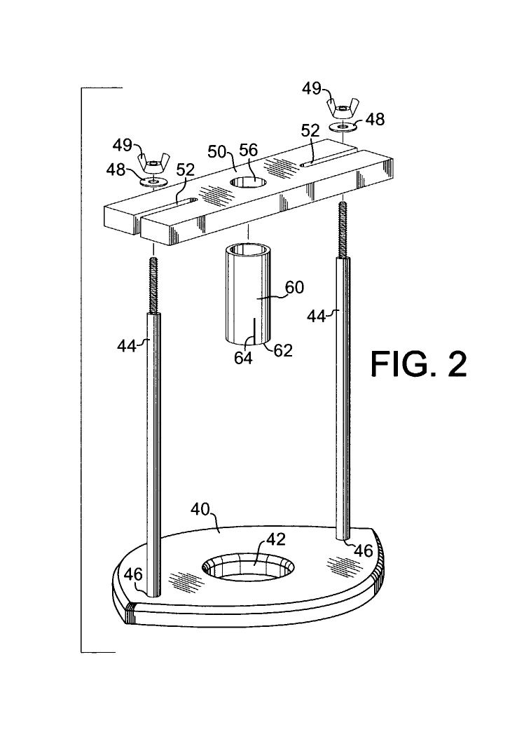

The bowling ball thumb-hole duplication jig 10 comprises a jig base 40 having a vertical jig base bore 42 as shown in FIG. 2. Two bridge supports 44 are mounted to the base 40 and depend upwardly from the base. Preferably, as seen in FIG. 2, the bridge supports 44 are equally spaced from and parallel to a vertical axis of the jig base bore 42 and said supports depend vertically from the base 40. Preferably, the supports 44 are made from stainless steel rods, but other suitable materials can be used. The supports 44 are spaced far enough apart to allow a regulation bowling ball 22 (a ball having a circumference of 27 inches) to rest supported in the jig base bore 42 and centered between the supports. Preferably, the lower ends of the supports 44 are mounted in two support mounting bores 46 through the base 40 and the supports are fixed to the base by threads on the lower ends of the supports and by cooperating nuts (threads and nuts not shown, but a technique well known to the mechanical arts). In the preferred embodiment, each upper end of the supports 44 is threaded to receive respectively a washer 48 and a wing nut 49.

The two supports 44 are attached to a clamping bridge 50. Preferably, the clamping bridge 50 has two bridge support slots 52, one at each end as seen in FIGS. 1 and 2. Each of the bridge support slots 52 respectively receives a bridge support 44 and cooperates with the bridge support, a washer 48, and a wing nut 49 to secure the bridge 50 to the jig base 40.

As seen in FIGS. 3, 6, and 9, the clamping bridge 50 has a centered lower bridge bore 54 that partially extends into the bridge 50 perpendicularly from its lower surface. The lower bridge bore 54 is coaxial with and has a larger diameter than an upper bridge bore 56 that extends fully through the bridge 50 perpendicularly from its top surface.

As seen in FIG. 3, a cylindrical tube 60 having an inside diameter greater than the diameter of the original thumb-hole 20 is closely, removably, and coaxially received into and seated in the lower bridge bore 54. Preferably, the tube 60 has a uniformly chamfered outer end 62 as seen in FIGS. 3, 6, and 9. Preferably, the tube 60 has a longitudinal tube registration marking 64 on its outer circumference at the chamfered outer end 62 and has a fill line 66 on its inner surface near the chamfered outer end. Preferably, the tube 60 is made of PVC tubing.

Preferably, the upper bridge bore 56 has the same diameter as the inside diameter of the tube 60. Preferably, the inside diameter of the tube 60 is 1 and ⅜ inches which is the maximum allowed diameter for a hole drilled in a bowling ball under American Bowling Congress regulations.

When the bowling ball thumb-hole duplication jig 10 is to be used, the jig is first placed on a level and secure work surface and then an original bowling ball 22 is placed in the jig base bore 42 on the jig base 40. The thumb-hole 20 of the ball 22 is then centered in the jig 10 with the thumb-hole centered at the highest point of the resting ball by eye by sighting along a plane through the vertical axes of the supports 44 with the plane equally dividing the observed thumb-hole and by using a measuring tape or steel rule perpendicular to the vertical axis of the supports 44 to equally space the thumb-hole from each support. Preferably, the thumb-hole 20 is also leveled in the jig 10 by the use of a bubble level laid across the thumb-hole.

Preferably, just before the jig 10 is assembled and tightened around a ball 22, the inside of the tube 60 and the thumb-hole 20 are liberally sprayed with a suitable mold release spray.

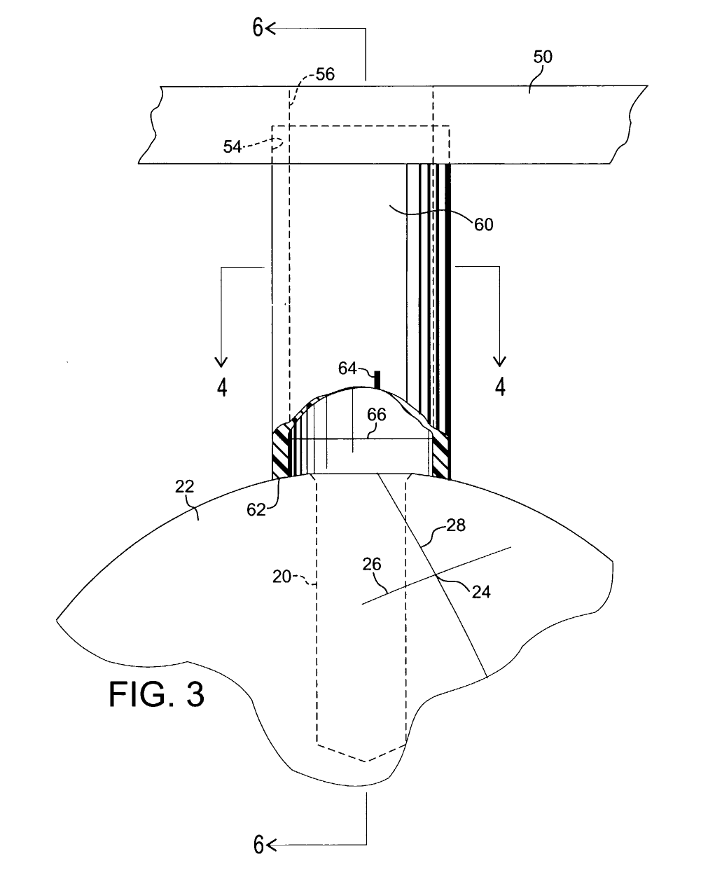

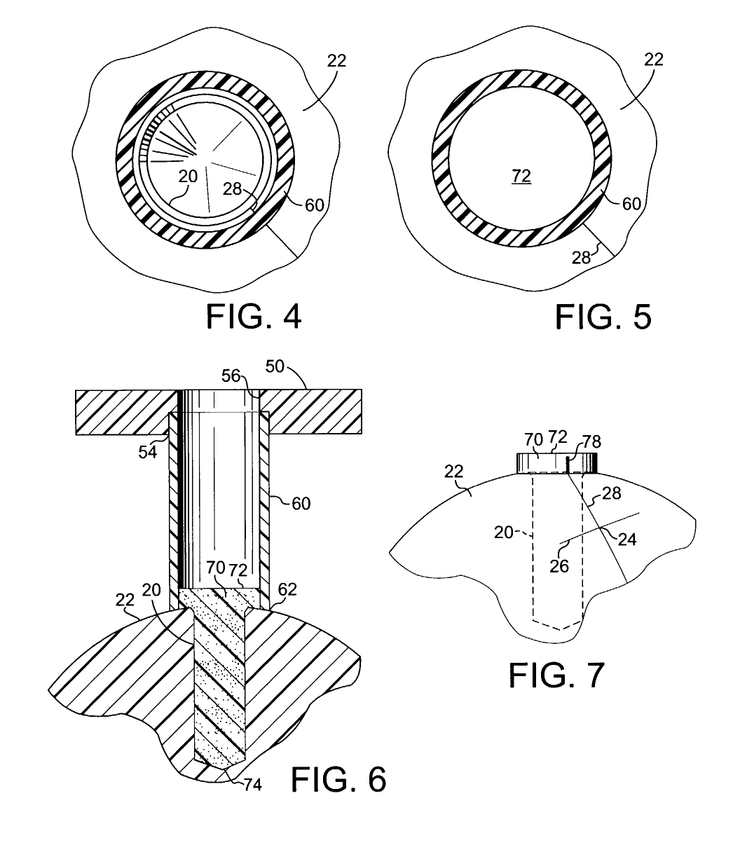

As seen in FIGS. 1, 3, and 6, the bowling ball thumb-hole duplication jig 10 in its preferred embodiment is assembled around a ball 22 with the chamfered outer end 62 of the tube 60 evenly resting on and closely abutting the ball and encircling the thumb-hole 20. Preferably, the jig 10 is assembled with the tube 60 aligned radial to the center of the ball 22 and the tube registration marking 64 aligned with the y-axis of the grip 28 of the ball 22. The jig 10 is then tightened around the ball. FIG. 4 shows a portion of the y-axis of the grip 28 encircled by the tube 60, a portion of the y-axis outside the tube, and the original thumb-hole 20.

As best seen in FIG. 1, with a ball 22 in place in the assembled bowling ball thumb-hole duplication jig 10, the clamping bridge 50 and the tube 60 are pressured in unison down along a radius of the ball 22 and towards the jig base 40 by tightening the two wing nuts 49. With a ball 22 in place in the jig 10, the chamfered outer end 62 is tightened down onto the ball by tightening the two wing nuts 49 on the two bridge supports 44 whereby the chamfered outer end cooperates with the surface of the ball to temporarily seal an interface between the surface of the ball and the chamfered outer end.

Preferably, after a ball 22 is centered in place, after the inside of the tube 60 and the thumb-hole 20 are liberally sprayed with a suitable mold release spray, and after the jig 10 is assembled and tightened around the ball, a flexible mold 70 is cast by pouring a mold material down through the upper bridge bore 56 to fully fill the thumb-hole 20 and partially fill the tube 60 as shown in FIG. 6. Preferably, the tube 60 is filled up to a fill line 66. The compressed and close interface between the surface of the ball 22 and the chamfered outer end 62 prevents the leakage of any mold material out from within the tube 60. When cured, the flexible mold 70 has a top end 72 and a bottom end 74. FIG. 5 shows the top end 72 of the mold 70 within the tube 60.

FIG. 6 shows the preferred relationships during the casting of a mold 70 between and among the bridge 50, the tube 60, the chamfered outer end 62, the ball 22, the mold, and the thumb-hole 20.

Preferably, the mold release spray is Pol-Ease® 2300 (Polytek mold release spray) available from Polytek® Development Corp. of Easton, Pa. or some other suitable mold release spray that allows a mold 70 after curing to be removed from the thumb-hole 20 and the tube 60 without damage to the mold.

Preferably, the pourable mold material used to cast the mold 70 is a two part flexible polyurethane material such as Poly 74-30 that is available from Polytek® Development Corp. of Easton, Pa. or some other suitable mold material that when cured is flexible and forms a mold that can be removed without damage from the thumb-hole 20 and the tube 60. Other mold materials such as silicone mold rubber can also be substituted for the Poly 74-30 and used for casting a mold 70.

After the mold 70 is cured, the two wing nuts 49 are loosened and the clamping bridge 50 and the tube 60 are removed from the jig 10 and away from the ball 22 and the mold 70. If the ball 22 has a scribed y-axis of the grip 28 that extends to the thumb-hole 20, then the position of the scribed y-axis along a radial of the thumb-hole 20 likely is discernable on the mold 70 as a radial ridge 76 on the surface of the mold resulting from molding of mold material within the tube 60 by the scribed y-axis within the tube. The ridge 76 indexes the mold 70 to the y-axis of the grip 28. Preferably, as shown in FIGS. 7, 8, and 10, even if a ridge 76 is discernable, the mold 70 is indelibly marked with a mold registration mark 78 to index the mold to the y-axis of the grip 28 at the point where the y-axis meets the mold.

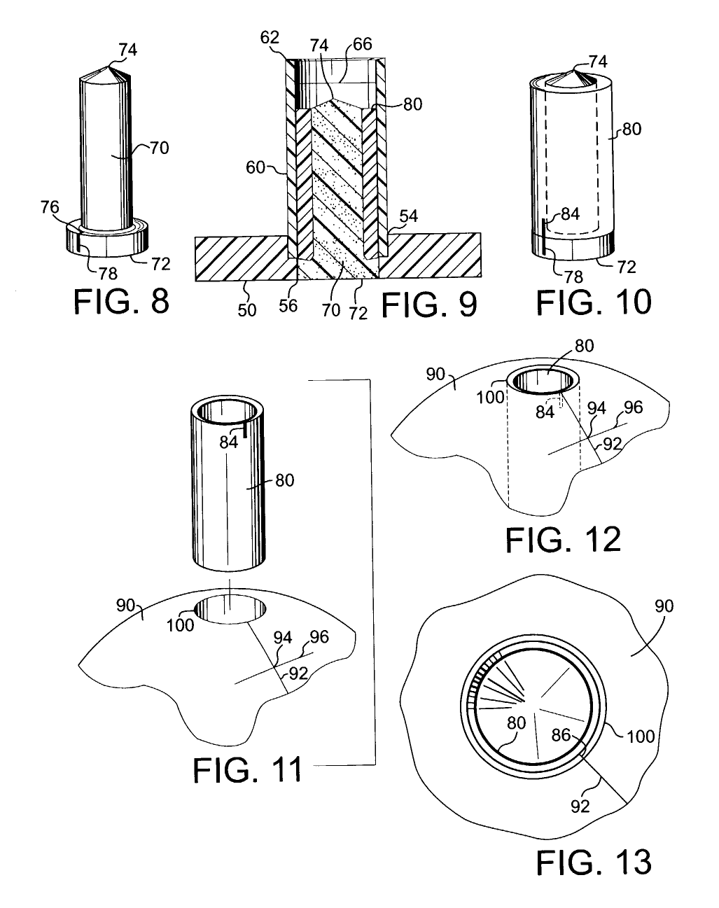

After the mold 70 is removed from the thumb-hole 20 as shown in FIG. 8, a slug 80 can be poured and cast. Preferably, the slug 80 is cast using the bridge 50, the tube 60, the mold 70, and a suitable slug casting material. As shown in FIG. 9, the mold 70 is removably mounted in the upper bridge bore 56 with its bottom end 74 extending vertically upward through the lower bridge bore 54 and into the tube 60 that is seated in the lower bridge bore.

Before the casting material is poured into the tube 60, the inside of the tube and the portion of the mold 70 open to the environment inside the tube are liberally sprayed with a suitable mold release spray such as Pol-Ease® 2300. Then a slug 80 is cast by pouring a slug casting material into the tube 60 to surround the mold 70 to a suitable depth. Preferably, as shown in FIG. 9, the tube 60 is filled to a depth to surround the mold 70 up to reach the vicinity of its bottom end 74 that in the casting process is the topmost part of the mold.

A suitable material for the pouring and casting of a slug 80 is Wizard Ball Plug, a two-part urethane material, available from Ultimate Bowling Products, Inc. of Key Largo, Fla. Similar urethane materials from other sources may also be used for casting of a slug 80. Additional materials known in the art and used for plugging holes in bowling balls may also be suitable for use in making a slug 80.

After the slug 80 has cured, the slug and the mold 70 are removed from the bridge 50 and the tube 60. Preferably, as shown in FIG. 10, the slug 80 is indelibly marked with a slug registration mark 84 aligned with the mold registration mark 78 before the slug is separated from the mold 70 to index the slug to the mold and the mold registration mark.

If the mold 70 has a radial ridge 76, then after separation from the mold, the slug 80 may have a discernable radial groove 86 that is aligned with the slug registration mark 84.

A second bowling ball 90 is provided having a y-axis of the new grip 92 marked thereon. Preferably, the y-axis of the new grip 92 is a scribed line, but it can be a temporary marking. The alignment of the slug registration mark 84 with the mold registration mark 78 indexes the slug 80 to the y-axis of the grip 28 of the original ball 22 and allows proper indexing of the slug to the y-axis of the new grip 92 of a second bowling ball 90. The second bowling ball 90 may also have a center of the new grip 94 and an x-axis of the new grip 96 scribed or marked thereon.

As shown in FIG. 11, a radial slug receiving bore 100 with the same diameter as the inside diameter of the tube 60 is made preferably by drilling in the second bowling ball 90 radial to the center of the ball and centered on the y-axis of the new grip 92 of the second bowling ball. The slug receiving bore 100 is sized to closely receive the slug 80 and made deep enough to receive the slug flush with the surface of the ball.

As shown in FIG. 11, the end of the slug 80 away from the slug registration mark 84 is inserted first into the slug receiving bore 100.

Before insertion of the slug 80 into the slug receiving bore 100, a suitable adhesive such as Elmer's Krazy Glue or another suitable quick bonding adhesive is applied to a portion of the receiving bore to secure the slug in place within the receiving bore with the slug registration mark 84 aligned with the y-axis of the new grip 92 of the second bowling ball 90 upon full insertion of the slug into the receiving bore as shown in FIG. 12.

If a radial groove 86 is discernable on the slug 80, then upon full insertion of the slug into the receiving bore 100, the radial groove is also aligned with the y-axis of the grip 92 as shown in FIG. 13.

If a ball 22 or 90 does not have scribed x-axis and y-axis lines through the center of the grip, then such scribed lines may be replaced by temporary lines marked on the surface of the ball with a suitable marker such as a crayon, wax pencil, or grease pencil.

Preferably, the jig base 40 and the clamping bridge 50 are made from white polypropylene plastic, but other suitable materials can be used.

Alternatively, the two bridge supports 44 can be made of flexible cable, wire, or other suitable material. In such alternative embodiments, the preferred securing means of two washers 48 and two wing nuts 49 can be replaced with other securing means such as hooks or loops or knobs or knots or other suitable devices that secure the alternative supports to the clamping bridge 50 and allow tightening of the bridge and the tube 60 down onto the ball 22.

Alternatively, the two bridge supports 44 can be replaced with springs or elastic cords that are connected by securing means to the bridge 50 such that said springs or elastic cords pull the bridge and tube 60 down onto the ball 22.

The preceding description and exposition of the invention is presented for purposes of illustration and enabling disclosure. It is neither intended to be exhaustive nor to limit the invention to the precise forms disclosed. Modifications or variations in the invention in light of the above teachings that are obvious to one of ordinary skill in the art are considered within the scope of the invention as determined by the appended claims when interpreted to the breath to which they fairly, legitimately and equitably are entitled.

I claim:

1. A bowling ball thumb-hole duplication jig comprising:
a jig base having a vertical jig base bore, two bridge supports mounted to said base, said supports depend upwardly from said base, said supports equally spaced from said vertical jig base bore, said supports attached to a clamping bridge, said clamping bridge having a lower bridge bore, and a tube received into and seated in said lower bridge bore.

2. A bowling ball thumb-hole duplication jig according to claim 1 wherein said lower bridge bore partially extends into said bridge perpendicularly from its lower surface, said lower bridge bore being coaxial with an upper bridge bore, said lower bridge bore having a larger diameter than said upper bridge bore, said upper bridge bore extends fully through said bridge perpendicularly from its top surface.

3. A bowling ball thumb-hole duplication jig according to claim 1 wherein said tube having a chamfered outer end.

4. A bowling ball thumb-hole duplication jig according to claim 2 wherein said tube having a chamfered outer end.

5. A bowling ball thumb-hole duplication jig according to claim 2 wherein said upper bridge bore having the same diameter as the inside diameter of said tube.

6. A bowling ball thumb-hole duplication jig according to claim 1 wherein said tube having a tube registration marking.

7. A bowling ball thumb-hole duplication jig according to claim 2 wherein said tube having a tube registration marking.

8. A bowling ball thumb-hole duplication jig comprising:
a clamping bridge, said clamping bridge having a centered lower bridge bore, said lower bridge bore partially extending into said bridge perpendicularly from its lower surface, said lower bridge bore being coaxial with and having a larger diameter than an upper bridge bore, said upper bridge bore extending fully through said bridge perpendicularly from its top surface, a pipe coaxially received into and seated in said lower bridge bore, said bridge having two bridge support slots, one at each end, each of said slots respectively receiving a bridge support and cooperating with said support, a washer, and a wing nut to secure said bridge to a jig base.

9. A bowling ball thumb-hole duplication jig according to claim 6 wherein said tube has a chamfered outer end.

10. A bowling ball thumb-hole duplication jig according to claim 6 wherein said upper bridge bore having the same diameter as the inside diameter of said tube.

11. A method for duplicating a thumb-hole from an original bowling ball into another bowling ball, said method comprising the steps of:
a. providing an original bowling ball having a thumb-hole; said ball having a marking on its surface showing a y-axis of the grip;
b. providing a bowling ball thumb-hole duplication jig having a jig base having a vertical jig base bore, two bridge supports mounted to said base, said supports depend upwardly from said base, said supports equally spaced from said vertical jig base bore, said supports attached to a clamping bridge, said clamping bridge having a lower bridge bore, said lower bridge bore partially extends into said bridge perpendicularly from its lower surface, said lower bridge bore being coaxial with an upper bridge bore, said lower bridge bore having a larger diameter than said upper bridge bore, said upper bridge bore extends fully through said bridge perpendicularly from its top surface, a tube received into and seated in said lower bridge bore, said tube having a chamfered outer end, and said tube having a tube registration marking on its outer circumference at said chamfered outer end;
c. placing said ball in said jig base bore;
d. centering said thumb-hole in said jig;
e. assembling said jig around said ball with said chamfered outer end evenly resting on and closely abutting said ball and encircling said thumb-hole, said tube aligned radial to the center of said ball, and said tube registration marking aligned with said y-axis of the grip;
f. tightening said jig around said ball;
g. casting a mold by pouring a mold material down through said upper bridge bore to fully fill said thumb-hole and partially fill said tube;
h. after said mold is cured, removing said clamping bridge and said tube from said jig;
i. marking said mold with a mold registration mark to index said mold to said yaxis of the grip at the point where said y-axis of the grip meets said mold;
j. removing said mold from said thumb-hole, said mold having a bottom end;
k. mounting said mold in said upper bridge bore with said bottom end extending vertically upward through said lower bridge bore and into said tube, said tube seated in said lower bridge bore;
l. casting a slug by pouring a slug casting material into said tube to surround said mold to a suitable depth;
m. after said slug is cured, removing said slug and said mold from said bridge and said tube;
n. marking said slug with a slug registration mark aligned with said mold registration mark to index said slug to said mold and said mold registration mark;
o. providing a second bowling ball having a y-axis of the new grip marked thereon;
p. making a radial slug receiving bore in said second bowling ball;
q. applying an adhesive to a portion of said receiving bore; and
r. inserting said slug intd said slug receiving bore with said slug registration mark aligned with said y-axis of the new grip.

12. A method for duplicating a thumb-hole from an original bowling ball into another bowling ball according to claim 11 wherein said radial slug receiving bore is centered on said y-axis of the new grip.

13. A method for duplicating a thumb-hole from an original bowling ball into another bowling ball according to claim 11 said method further comprising the steps of:
a. spraying the insides of said tube and said thumb-hole with a mold release spray before said jig is assembled and tightened around said ball; and
b. spraying the inside of said tube and said mold open to the environment inside said tube with a mold release spray before said casting material is poured into said tube.
